(19) United States
(12) Patent Application Publication
(10) Pub. No.: US 2008/0139112 A1
(43) Pub. Date: Jun. 12, 2008

(54) INTELLIGENT PERSONALIZED CONTENT DELIVERY SYSTEM FOR MOBILE DEVICES ON WIRELESS NETWORKS

(76) Inventors: Hari Prasad Sampath, Bangalore (IN); Pedar Arulanandam, Bangalore (IN)

Correspondence Address: Vern Maine & Associates, 100 MAIN STREET, P O BOX 3445, NASHUA, NH, 03061-3445, US

(21) Appl. No.: 11/934,802

(22) Filed: Nov. 5, 2007

Related U.S. Application Data
(60) Provisional application No. 60/874,003, filed on Dec. 11, 2006.

(51) Int. Cl. H04H 60/09

(52) U.S. Cl. 455/3.04

(57) ABSTRACT

The intelligent personalized content delivery system described herein generally includes a wireless mobile device, a mobile network infrastructure, an intelligent personalized content delivery server, and content database. The mobile device transmits the user content request to mobile network infrastructure over the wireless link to the server. Once the requested content is identified, the server obtains the requested content from the content database and generates a response for the wireless mobile device, where the response conveys at least a portion of the requested content or a link to download content. The personalized content delivery server includes an intelligent subsystem that processes the mobile user content request automatically and learning the mobile user content preferences and building an intelligent recommendation database for the mobile user. The recommendation database is used to recommend personalized content and also send targeted advertisements.

### TECHNICAL FIELD OF THE INVENTION

The present invention relates generally to content delivery on wireless networks including mobile access networks. More particularly, this invention relates to systems and methods for intelligent content delivery for providing personalized content to mobile users based on preferences of the mobile users learnt on-the-fly by the intelligent system and also based on users content preference history, choices and a set of appropriate rules defined by the system.

### BACKGROUND OF THE INVENTION

The prior art is replete with different content delivery methods and systems which push content to the mobile users or deliver content as requested by the mobile user. Mobile devices include mobile or cellular phones, smart phones, personal digital assistants (“PDAs”) supporting mobile connectivity, palmtop computers supporting mobile connectivity, laptop mobile computers supporting mobile connectivity, and the like. These mobile devices function as wireless communication devices via a wireless communication link (GSM, GRPS, 3G, CDMA and the like) and access content over the wireless network infrastructure setup by the Mobile Network Operators like Cingular and Verizon Wireless in the USA, Airtel and Hutch in India.

Traditional content delivery systems push content to the mobile users as per user's requests or otherwise spamming the user with irrelevant content. For example, a user interested in sports may be sent content related to movies as part of advertising. This might not be acceptable to the user. In this example based on traditional content delivery systems, it is impossible for the content solutions providers and advertisers to reach the intended target audience with the right personalized content as per users liking. On the other hand, the user is irritated by irrelevant content and may resort to possible legal action against the content providers. Also, few content delivery systems provide some personalization and these systems requires frequent interactions with the mobile user and requires the mobile user to explicitly rate content and/or recommendations delivered to the mobile device, which turns out to be a cumbersome process if the mobile user has to rate various content items. With the gamut of content options available to the mobile users, this turns out to be a constantly nagging problem for the mobile user to rate every content item received or content recommendation received, so as to improve the accuracy of the type of content items received in future.

Accordingly, it is desirable to have a technique for intelligent delivery of content to deliver personalized content as per user's preferences and likings with minimal or no interaction from the user. In addition, it is desirable to have a content system that can learn user preference on-the-fly in the absence of users preference history and also dynamically change users preferences as and when his pattern of liking for a particular class of content changes. It is also desirable to have the mobile user opt-in or opt-out for any content services. Furthermore, other desirable features and characteristics of the present invention will become apparent from the subsequent detailed description and the appended claims, taken in conjunction with the accompanying drawings and the foregoing technical field and background.

### BRIEF SUMMARY OF THE INVENTION

A server system that recommends and supports intelligent and personalized content delivery over wireless mobile access networks and related operating methods are described herein. The server system includes an intelligent Recommendation engine that processes queries received through the User Interface to recommend a group of mobile users based on certain requested parameters for targeted personal content delivery or advertising. For example the mobile operator or the content provider wants to reach a set of potential customers interested in a new book release of “Harry Potter” by author J. K. Rowlings, then using the intelligent personalized content delivery system described herein, a group of mobile users can be identified and personally targeted with content or advertising about this new release of the book based on the intelligent recommendations generated by the system. To accomplish this, the intelligent recommendation engine interacts with several sub-systems like the profiling engine, the prediction engine, and other system databases like the rules database, preference database, history database, content database to generate a content recommendation database. The server system can communicate this generated recommendation and transmit the recommended content and/or advertisements in an appropriate format for presentation at the mobile device of the targeted user through the mobile operator network.

The above and other aspects of the invention may be carried out in one form by a method for intelligent and personalized content delivery for mobile devices over wireless networks. The method involves: acquiring the mobile user preference through predefined registration of user preferences and/or automatically learning the user preferences on the fly when the mobile user accesses content over the wireless networks; decoding the relevant content accessed by a user when the user is accessing content hosted by mobile and internet service providers and/or analyzing various transaction details of the mobile user from transaction detail records or transaction logs or transaction server logs from service providers (including but not limited to mobile operators/internet service providers/value added services providers/electronic and mobile commerce payment gateway service providers) when available, caching the user content data in desired format for further analysis by the system, building a history database for every mobile user based on standard rules as defined by the system, building preferences database and the mobile users content access patterns, building a recommendation database periodically as predefined by the system or building a recommendation database when an authorized administrator queries the intelligent recommendation engine with parameters for generating a group of target audience for a particular class of content or advertising, transmitting the relevant personalized content or part of the recommended content like a Uniform Resource Locator (URL) related to the content/advertisement, advertising content to the mobile users using the mobile operator network based on the recommendations database generated by system in accordance with a mobile wireless communication protocol.

### BRIEF DESCRIPTION OF THE DRAWINGS

The preferred embodiments of the invention will hereinafter be described in conjunction with the appended drawings provided to illustrate and not to limit the invention, wherein like designations (reference numbers) denote like elements, and in which: refer to similar elements throughout the figures.

FIG. 1 is a schematic representation of the intelligent personalized content delivery system according to an example embodiment of the invention;

FIG. 2 is a block diagram of intelligent personalized content delivery server system interfacing with GSM/GPRS/CDMA/3G mobile access network according to an example embodiment;

FIG. 3 is a schematic representation of the intelligent personalized content delivery server system (iPCDS) of FIG. 1 according to some embodiment;

FIG. 4 is a schematic representation of the intelligent recommendation engine of FIG. 3 according to some embodiment;

FIG. 5 is a schematic representation of the profiling engine of FIG. 4 according to some embodiment;

FIG. 6 is a schematic representation of the prediction engine of FIG. 4 according to some embodiment;

FIG. 7 is a timing diagram that represents the usage aspect and personalized content recommendation delivery by the server system; and,

FIG. 8 is a flow chart of a portion of a recommendation generation process and content delivery to a mobile device, as performed by the intelligent personalized content delivery server system (iPCDS);

### DETAILED DESCRIPTION OF THE INVENTION

The detailed description of this invention is illustrative in nature and is not intended to limit the invention or the application and uses of the invention. Furthermore, this invention is not intended to be bound by any expressed or implied theory presented in the preceding technical field, background, brief summary or the following detailed description.

The invention may be described herein in terms of schematic, functional and/or logical block components and various processing steps. It should be appreciated that such block components may be realized by any number of hardware, software, and/or firmware components configured to perform the specified functions. The invention may be realized employing various integrated circuit components, e.g., memory elements, processing elements, communication elements, logic elements, look-up tables, or the like, which may carry out a variety of functions under the control of one or more microprocessors or other control devices. The intelligent personalized content delivery server system (referred to as iPCDS herein) may be implemented on single computer or server architecture or on multiple computers or servers that may be interconnected through a network, such as the Internet or local area network. Also software and data storage associated with the system may reside on a single computer architecture system or server, or may be distributed across the multiple computers systems or servers. The system may integrate with existing types of computer software, such as computer operating systems, network operating systems, mobile telecommunication protocols, and internet transport protocols, special purpose devices such as “Content Delivery Platforms” or “Service Delivery Platforms”, interactive voice response systems (IVR), 3G IP Multimedia Subsystem (IMS), database software, application middleware, application software and/or application servers like SMS application server, MMS application server etc., content databases, content database servers, streaming data servers, electronic-commerce payment gateways, mobile-commerce payment gateways and next generation “Mobile TV and IPTV Platforms”. In addition, those skilled in the art will appreciate that the present invention may be practiced in conjunction with any number of telecommunication and data transmission protocols and that the system described herein is merely one exemplary application for the invention.

Conventional techniques related to computer device platforms, wireless telecommunication and data transmission, signaling network control, database management, and other functional aspects of the systems (and the individual operating components of the systems) may not be described in detail herein as it is known to those skilled in the art. Furthermore, the connecting lines shown in the various figures contained herein are intended to represent example functional relationships and/or physical couplings between the various elements. In practical embodiment, additional functional relationships or physical connections may be present. Also, additional intervening elements may be present in the actual embodiment with out altering the functionality of the system.

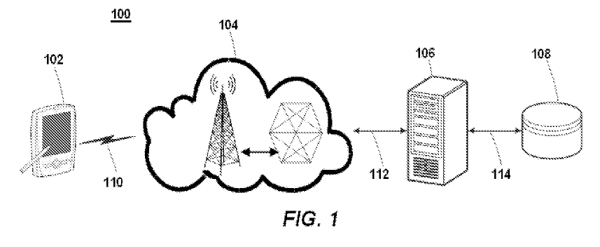

FIG. 1 is a schematic representation of the intelligent personalized content delivery system 100 according to an example embodiment of the invention. The intelligent personalized content delivery system and related techniques described in more detail below can be implemented in the mobile access network as shown in FIG. 1. (and other practical architectures). Intelligent personalized content delivery system 100 generally includes a wireless mobile device 102, a mobile access network infrastructure setup by a mobile service provider/operator 104; an intelligent personalized content delivery server (iPCDS) 106 deployed within the mobile operator network or remotely deployed network; and a content database 108. In operation, wireless mobile device 102 is coupled to mobile access network infrastructure 104, which is coupled to intelligent personalized content delivery server 106, which is coupled to content database 108.

Wireless mobile device 102 may support existing and future wireless technologies supporting wireless mobile communication, including, without limitation: cell phones (mobile phones), PDAs; portable computers such as laptops, palmtops, and tablet PCs; or general purpose mobile computing devices. The wireless mobile device 102 supports wireless communication with mobile operator infrastructure 104 via a wireless link 110. Such wireless communication, characteristics of wireless link 110, and the manner in which wireless link 110 is created and maintained may be governed by one or more applicable wireless communication protocols and/or one or more applicable signaling and network protocols. In the example embodiment, wireless mobile device 102 is configured to support Wireless GSM/GPRS/3G/CDMA/W-CDMA connectivity in compliance with established European Telecommunications Standards Institute (ETSI) standards, International Telecommunication Union (ITU) standards and Third Generation Partnership Project (3GPP) standards, International Telecommunication Union (ITU) standards and the like. Of course, wireless mobile device 102 may be configured to support alternate or additional wireless data communication protocols, including future variations of 3G such as 3.9G or 4G. Device 102 may also utilize other technologies like Bluetooth; IEEE 802.11a/b/g (WLANs); IEEE 802.16 (WiMAX); IEEE 802.20 etc.

Mobile access network infrastructure 104 is generally deployed and managed by mobile network operators (like Cingular in the USA or Airtel in India), who provide mobile services to the users based on a subscription model, where mobile users pay for voice, data and other supplementary services. The intelligent personalized content delivery server system (iPCDS) 106 is an intermediary between the mobile access network infrastructure 104 and the content domain where content is stored in content database 108. The content residing at content database 108 is transmitted over the mobile network operator infrastructure 104 to the end mobile subscriber 102 using the intelligent personalized content delivery server system (iPCDS) 106.

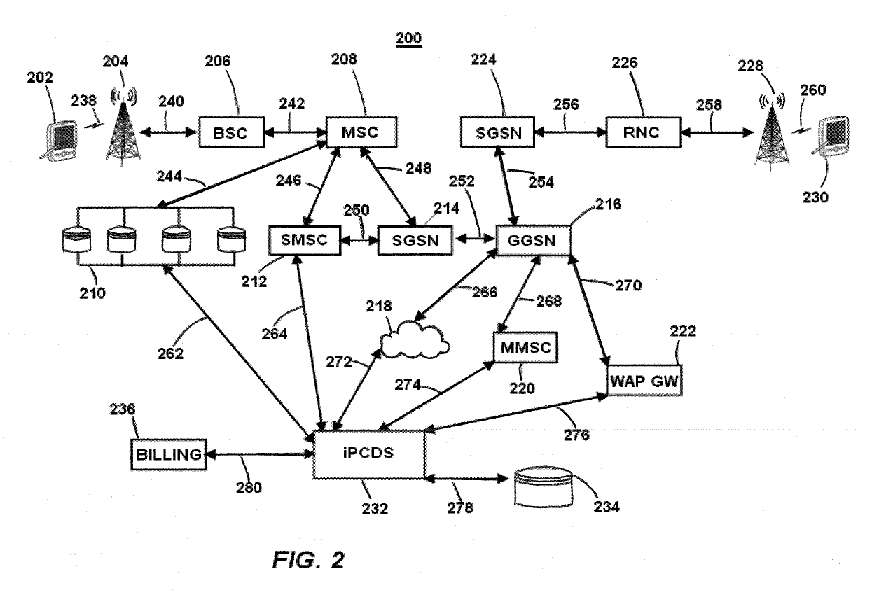

FIG. 2 is a block diagram of intelligent personalized content delivery server system interfacing with GSM/GPRS/CDMA/3G mobile access network according to an example embodiment. The block diagram of FIG. 2 shows the interfacing of the intelligent personalized content delivery server system 106 (see FIG. 1) with the mobile access network infrastructure 104 (see FIG. 1). In the example practical embodiment as shown in FIG. 2, intelligent personalized content delivery server system may include additional components, and functions that are unrelated to the intelligent personalized content delivery techniques described herein.

In practical embodiments of the invention shown in FIG. 2, the mobile device (GSM/GPRS capable) 202 and the mobile device (3G capable) 230 subscribe to the mobile operator services and communicate over the wireless link 238 and 260 respectively. The mobile device can send or receive data or voice over the communication link 238 in the GSM/GPRS environment and over the communication link 260 in the 3G environment.

In the GSM/GPRS environment, to send or receive data with the mobile operator network, the mobile device 202 transmits/receives data and voice traffic to the Base Transceiver Station (BTS) 204. This would be governed by standard communication protocols and procedures and are not described here. The BTS 204 couples with the Base Station Controller (BSC) 206 over the communication link 240. The BSC 206 couples with the Mobile Switching Center (MSC) 208 over the communication link 242. The MSC 208 couples with various Mobile operator databases 210 like Home Location Register (HLR), Visitor Location Register (VLR), Authentication Center (AUC), Equipment Identity Register (EIR) etc, over the communication link 244. The MSC 208 also couples with the Short Message Service Center (SMSC) 212 and Serving GRPS Support Node (SGSN) 214 over the communication links 246 and 248 respectively.

Likewise in the 3G environment, the mobile device 230 would send and receive data and voice traffic to NODE-B 228 over the communication link 260. This would be governed by standard communication protocols and procedures and are not described here. The NODE-B 228 couples with Radio Network Controller (RNC) 226 over the communication link 258. The RNC 226 couples with the 3G-Serving GPRS Support Node (3G-SGSN) 224 over the communication link 256. The 3G-SGSN couples with Gateway GPRS Support Node (GGSN) 216 over the communication link 254. The GSM/GPRS network and the 3G network couple over the communication link 252. The GGSN 216 exposes the mobile world to the internet 218 using the communication link 266. The Multimedia Messaging Service Center (MMSC) 220 and the Wireless Application Protocol Gateway (WAP-GW) 222 couple with the GGSN 216 over the communication link 268 and 270 respectively. Although the schematics shown in FIGS. 1-2 depict example arrangements of elements, additional intervening elements, devices, or components may be present in an actual embodiment (assuming that the functionality of the system is not adversely affected). The design and operation of mobile network infrastructure components (104 of FIG. 1 and components shown in FIG. 2) described herein are known to those skilled in the art and, therefore will not be described in detail.

The intelligent personalized content delivery server system (iPCDS) 232 of FIG. 2 couples with various components of the mobile network infrastructure 104 (see FIG. 1) as described below. The iPCDS 232 couples with the Mobile Operator Databases 210 using the communication link 262. The manner in which the communication channel is established and maintained over physical link 262 may be governed by one or more applicable communication protocols and/or signaling protocols like the ETSI GSM MAP protocol specification and the like. The iPCDS 232 couples with the SMSC 212 to send and receive SMS messages over the mobile network infrastructure 104 (see FIG. 1) using the communication link 264. The manner in which communication channel is established and maintained over physical link 264 may be governed by one or more applicable communication protocols and/or one or more applicable network protocols like SMPP (used by Logica/CMG), CIMD2 (used by Nokia). The iPCDS 232 couples with the internet 218 using the communication link 272. This can include various standardized data communication protocols like the TCP/IP, IEEE 802.3 and the like. Using the link 272 the iPCDS 232 can send or receive any content to the mobile world using the internet The iPCDS 232 couples with the MMSC 220 using the communication link 274 to send and receive MMS messages. The manner in which communication channel is established and maintained over physical link 274 may be governed by one or more applicable communication protocols and/or one or more applicable network protocols like MM7 protocol. The iPCDS 232 couples with the WAP-GW 222 using the communication link 276 to transfer WAP pages and related content. The manner in which communication channel is established and maintained over physical link 274 may be governed by one or more applicable communication protocols and/or one or more applicable network protocols.

The iPCDS 232 couples with the content database 234 using the communication link 278. The system 232 can communicate with the content database 234 to retrieve content data as requested by the user, and/or transmit personalized content or advertising content based on intelligent recommendations built by the iPCDS 232 in an appropriate format for presentation at the wireless mobile device 202 in the GSM/GRPS world or mobile device 230 in the 3G world. The manner in which a data communication channel is established and maintained over physical link 278 may be governed by one or more applicable data communication protocols, one or more database management protocols, and/or one or more applicable network protocols. In practice, content database 234 may leverage well known data storage, database management, and other database-related technologies. The manner in which data is accessed and retrieved by the iPCDS 232 from content database 234 complies with conventional protocols and standards. Practical implementations of the content database 234 may be implemented on single computer or server architecture or on multiple computers or servers that may be interconnected through a network, such as the Internet or local area network. Also software, and content associated with the system may reside on a single computer architecture system or server, or may be distributed across the multiple computers systems or servers. The content database can be suitably configured to handle all types of content including, but not limited to Hyper Text Transfer Protocol (HTTP) Web pages, XML pages, RSS feed formats, WAP pages, games, graphics, mobile Ring Tones and MMS files, MPEG files, MP3 files, MOV files, JPEG files, GIF files, streaming video files, video files, Real Networks RealAudio and RealVideo, Windows media formats, 3GPP file formats (H.263, H.264, etc.), Apple QuickTime formats etc. The content database may also reside on known content servers like the Apache Web servers, Microsoft Content Management servers, Microsoft XP servers or Windows 2003 servers, Real Networks Helix servers, Tandberg Content servers, and Apple Quicktime servers etc.

In this regard, the iPCDS 232 when coupling with the mobile infrastructure network 104 (see FIG. 1) and when coupling with the content databases or servers 234 (see FIG. 2) may include other traditional connectors, LAN data cables, LAN switches like Cisco 3500 series, Internet routers like Cisco 7200 series, Load Balancers and Content Services Switches like Cisco CSS 11500 family series, Firewalls and VPN security devices etc. The iPCDS 232 may also be coupled with other application servers including, but not limited to SMS application servers, MMS application servers and the like.

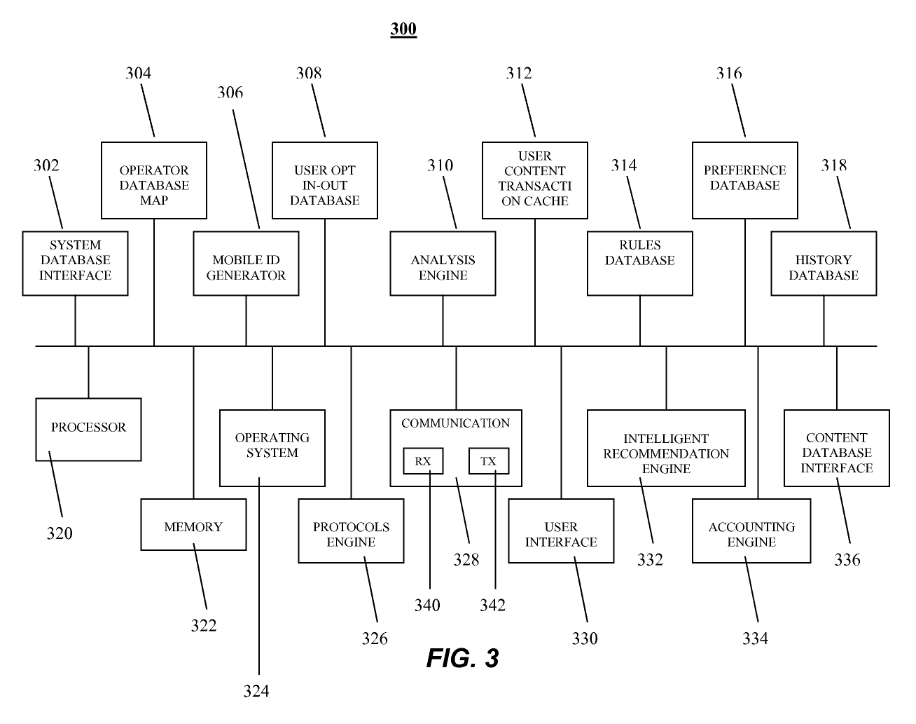

The iPCDS 232 couples with the mobile operator Billing systems 236 using the communication link 280. The accounting engine 334 (see FIG. 3) generates log files containing Transaction Details for specific transactions made by the mobile user while accessing certain content which need to be billed to the end mobile user. Such billing events are submitted through this interface to the mobile operator billing system 236 through the communication link 280. The manner in which communication channel is established and maintained over physical link 280 may be governed by one or more applicable communication protocols and/or one or more applicable network protocols and would be evident to those skilled in the art.

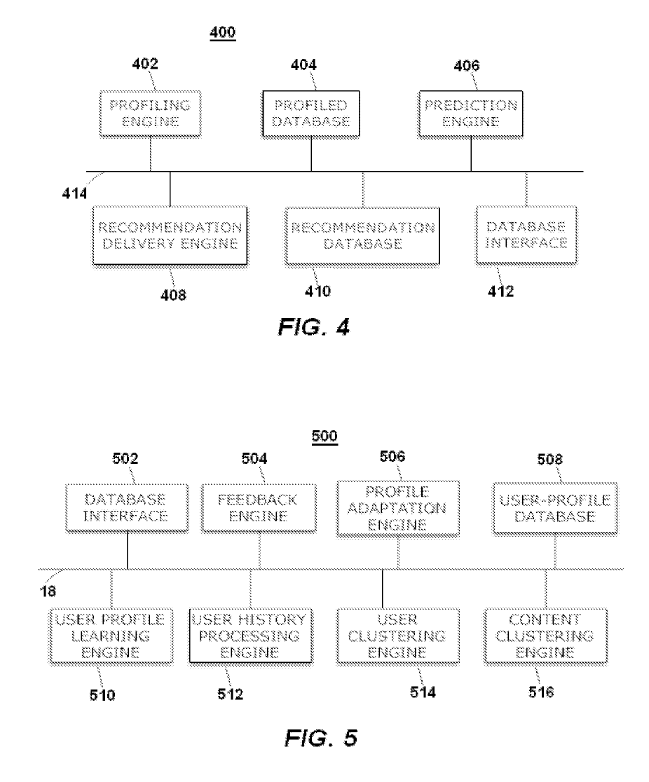

FIG. 3 is a schematic representation of the intelligent personalized content delivery server system (iPCDS) 300 in accordance to some example embodiment. iPCDS 300 is suitable to be used in intelligent personalized content delivery system 100 (see FIG. 1). iPCDS 300 generally includes a system database interface 302, operator database map 304, a mobile ID generator 306, a user opt-in-out database 308, an analysis engine 310, a user-content transaction cache 312, a rules database 314, a preference database 316, a history database 318, processor architecture 320, memory 322, an operating system 324, protocols engine 326, communication element 328 with receive element RX 340 and transmit element TX 342, an user interface 330, an intelligent recommendation engine 332, an accounting engine 334, and content database interface 336. iPCDS 300 may include a suitable interconnect architecture 338 that couples the various elements together. Interconnect architecture 338 allows the various elements of the iPCDS 300 to communicate with each other and transfer data as needed. The iPCDS 300 includes software and algorithms for tracking mobile users' interaction with the system and sub-system elements, and generate intelligent personalized recommendations stored in the recommendation database 410 (see FIG. 4) for content and advertisements delivery based on the mobile user's content access behaviors, rules and preferences. The content and advertising based on intelligent recommendations may be sent to the mobile user periodically or when the mobile user is accessing content. In a practical embodiment, server 300 may include additional features, components, functions and applications related to content delivery systems that are may not affect the adversely affect the functionality of the intelligent personalized content delivery techniques described herein. Likewise in practical embodiments, server 300 may incorporate various sub-systems described herein into fewer system components and functional blocks with out adversely affecting the functionality of the intelligent personalized content delivery techniques.

System database interface 302 may represent hardware, software, and/or processing logic that enables sub-systems of iPCDS 300 to communicate with system databases like operator database map 304, user opt-in-out database 308, rules database 314, preference database 316, history database 318, and recommendation database 410 (see FIG. 4) using the native language, database management protocols, and nomenclature of the database. For example, system database interface 302 is suitably configured to create a database query for a data requested by the administrator using the user interface 330 for a group of mobile users in the age group 20-30 who are interested in romantic books. The system database interface 302 formats the database query for compliance with the database, and to make the database query available for transmission to the database. Moreover, system database interface 302 obtains the requested data (or a portion thereof) from the database so that server 300 can process the requested data in an appropriate manner.

Operator database map 304 is a database containing information about mobile subscribers and associated information. This database consists of two internal databases. One internal database contains mobile user data collected from the mobile operator like (Cingular in the USA and Airtel in India) and the other internal database contains intelligent personalized content recommendations for mobile users to be used by the mobile operator to deliver content or advertisements to his subscribed mobile users. This data is restricted and governed by legislations and guidelines as provided by the mobile operator. The operator database map 304 may also contain an alias to the actual mobile number to hide and protect the privacy of the user. For example, a mobile user in India with a number +919880080310 may be represented in this operator database map 304 with an alias so that the real mobile number is not exposed outside. This can be any uniquely identifiable number called the mobile ID which maps on to the actual mobile number as provided by the mobile operator. Mobile ID can be any uniquely identifiable number generated and designated by the mobile ID generator 306 of the iPCDS 300 for all internal references, storage and processing of associated attributes, preferences, history and generated intelligent recommendations for mobile user. For example, the mobile ID may be any unique identifier, including but not limited to an unique alias mobile number as provided by the mobile operator to identify a particular mobile number or International Mobile Subscriber Identity (IMSI) number or an unique alias number (like a random number generated by a random number generator algorithm) generated by the mobile ID generator 306 or a medium access control address (MAC address) of a mobile device etc. The generation of a unique mobile ID is equivalent to generating a unique number (like a non-negative integer number or a hexadecimal number) which will map back to the actual mobile number of the user. The unique number generation is know to those skilled in the art and is hence not described herein.

The user opt-in-out database 308 contains mobile user preference of opting-in for receiving any content/advertising or opting-out of any content/advertising or opting-in for certain partial services of the service provider. The iPCDS 300 will not process any information or delivery any personalized recommendation content/advertising for mobile users who have opted-out for any content and advertising by this iPCDS 300.

Analysis Engine 310 represent hardware, software, and/or processing logic that enables iPCDS 300 analyze real-time traffic passing though the iPCDS 300 when content hosted on content database 234 (see FIG. 2) is being accessed by the GSM/GPRS mobile user 202 (see FIG. 2) or 3G mobile user 230 (see FIG. 2) through the iPCDS 300 according to the example embodiment or analyze transaction detail records or transaction logs or transaction server logs or off-line captured transaction traffic packets of the mobile users available at the mobile operators/service providers. The analysis engine 310 may have packet decode engines, voice/speech recognition tools, web crawlers, data mining tools and pattern recognition tools. The decode engine can decode and analyze a plurality of protocols and data formats and voice including, but not limited to Internet Protocol (IPv4/IPv6) traffic, TCP traffic, UDP traffic, SMS traffic, MMS traffic, HTTP traffic, HTTP extension traffic like Composite Capability/Preference Profiles (CC/PP) exchange protocol (defined by World Wide Web Consortium—W3C), Voice SMS, Voice responses from the mobile user to an interactive voice response system hosted by the content provider etc., which transits through the iPCDS 300 when content is being accessed or when requesting content by the mobile user 202 or 230 (see FIG. 2) and/or when content is being pushed to the mobile user 202 or 230 from the content database 234 (see FIG. 2). The decode engine may have specific filters to capture certain specific traffic. The decode engine may have options to set filters to capture specific traffic, say, a filter to capture only HTTP traffic and analyze it. For example, when a GRPS/3G mobile user uses the mobile device 202 or 230 to access a certain HTTP webpage “www.ampelion.com” hosted by a certain content provider on the content database 234 in the sample embodiment as shown in FIG. 2, the decode engine (see FIG. 3) may decode and analyze this traffic. A portion of the decode after stripping other protocol headers may be as shown below:

Hypertext Transfer Protocol
GET /HTTP/1.1
   Request Method: GET
   Request URI: /
   Request Version: HTTP/1.1
Accept: image/gif, image/x-xbitmap, image/jpeg, image/pjpeg, application, */*
Accept-Language: en-us
Accept-Encoding: gzip, deflate
User-Agent: Mozilla/4.0 (compatible; MSIE 6.0; Windows NT 5.1)
Host: ampelion.com
Connection: Keep-Alive
Cookie: _utma=133453910.995991992.1162355012.1162355012.1162355012.1; _utmz=133453910.1162355012.1.1.utmccn=(direct)|utmcsr=(direct)|utmcmd=(none)

The mobile user now may access a link for cricket sports in ampelion.com page. A sample header decode for this behavior may be as illustrated below:

Hypertext Transfer Protocol
GET /worldcup.cms?in_leftnav HTTP/1.1
   Request Method: GET
   Request URI: /worldcup.cms?in_leftnav
   Request Version: HTTP/1.1
Accept: image/gif, image/x-xbitmap, image/jpeg, image/pjpeg, application, */*
Referer: http://ampelion.com/
Accept-Language: en-us
Accept-Encoding: gzip, deflate
User-Agent: Mozilla/4.0 (compatible; MSIE 6.0; Windows NT 5.1)
Host: cricket.ampelion.com
Connection: Keep-Alive
Cookie: _utma=133453910.995991992.1162355012.1162355012.1162355012.1; _utmz=133453910.1162355012.1.1.utmccn=(direct)|utmcsr=(direct)|utmcmd=(none)

From the above sample decode, the processing logic of the analysis engine 310 would extract relevant information about a particular mobile user. In the above example, the processing logic may extract information about a particular user and his content access pattern related to the sport “cricket” and/or any other information as required by the iPCDS 300 for further processing. This means that the mobile user may be interested in sports and particularly interested in the sport “cricket”. It should be understood and appreciated that the above example is merely an illustration of the technique used herein by the iPCDS 300 and those skilled in the art can apply these techniques to any traffic streams and protocols and also extract any relevant information from the data stream as required for processing. For example, the technique described herein may be practiced with any number of data forms like W3C CC/PP exchange protocol, SMS, MMS, Ring tones etc. The analysis engine 310 described herein may also be used to extract keywords from SMS messages, Voice SMS or IVR based requests (including voice short codes) sent to short codes hosted by the content provider using the iPCDS 300. The analysis engine 310 may also decode information in conjunction with other application servers like SMS application server. For example, a mobile user uses the mobile device 202 to send a SMS to the short code 5555 hosted by the content provider for downloading a ring tone. This Short Code in the SMSC 212 (see FIG. 2) is mapped to SMS Application Server hosted by the content provider which can interact with the iPCDS 300. The processing logic of the analysis engine 310 may extract information from the SMS Application Server about the language of the ring tone like English, Spanish, Hindi etc., the genre of the music like hard rock, instrumental, dance, trance etc for the mobile users. The processing logic of the analysis engine 310 caches this relevant information in the user-content transaction cache 312.

The processing logic of the analysis engine 310 may map the mobile user access pattern extracted as identified above to a unique mobile ID corresponding to a mobile user as designated by the mobile ID generator 306 as described earlier in section [0029]. This generated mobile user-content relationship is transmitted to the user-content transaction cache 312 using the interconnect architecture 338.

The user-content transaction cache 312 contains a list of mobile IDs and their content access patterns learnt on the fly using the analysis engine 310 of the iPCDS 300. The user profile learning engine 510 (see FIG. 5) acts upon the information in the user-content transaction cache 312 and profiles the mobile users based on standard rules defined in the rules database 314, preferences of the mobile user if available in the preference database 316 and would build a history of the mobile users in the history database 318.

The rules database 314 consists of two internal rule databases, one for the mobile users and other for the content items. The mobile users rules database consists of a set of standard and/or derived rules and logic to efficiently associate a particular mobile user or a group of mobile users to a particular recommendation group in the recommendation database 410 based on standard usage patterns as observed and/or identified. For example, when the intelligent recommendation engine 332 has to generate a certain recommendation for a group of mobile users in the age group of 35-45 years, the rules database may contain a rule associating the mobile user age group of 35-45 years to be interested in stock markets and financial news. The content items rules database may also contain a set of standard and/or derived rules and logic to efficiently associate a particular content item or a group of content items to a particular class of content. For example, when a new book like “Harry Potter” by J. K. Rowlings is released, there may be an associated rule identifying this book to a category of users in the age group of 10-25 years. This association may not be assumed to be the final, but would only be referred to by the intelligent recommendation engine 332 when making a recommendation. In practical embodiments, it may also translate that a particular mobile users or a group of mobile users in the age group of 40-50 are also interested in this “Harry Potter” book. It should be appreciated that rules only define certain associations and the intelligent recommendation engine 332 logic may override the rules logic in certain recommendations. The rules database 314 will not have the actual mobile number of the mobile user to protect the privacy, but would have a unique mobile ID as designated by the mobile ID generator 306.

The preference database 316 is a database containing the preferences of the mobile users collected by the content provider of the iPCDS 300. The mobile user preferences may be collected through web registration on the content provider's web site and/or content service provider's web site or collected from the mobile network operator or collected through SMS key words or messages and/or other communication like web registration from the mobile device 202 or 230 (see FIG. 2) from the mobile user indicating user's preferences for a particular service or multiple services along with other personal, demographic data and/or preferential information as requested by the content provider using the iPCDS 300. For example, the information collected from the mobile user may include the age, location, gender, languages known, hobbies etc. The preference database 316 will not have the actual mobile number of the mobile user to protect the privacy, but would have a unique mobile ID as designated by the mobile ID generator 306.

The history database 318 is a database that contains the content usage pattern and/or content access history for mobile users of the iPCDS 300 for various content items as profiled by the intelligent recommendation engine 332. The content access history for a class of content or a content item may be indicated as a hit count. The hit count represents the frequency by which the mobile user accesses various content items like ring tones, web sites etc. For example, the history database 318 for a mobile user may contain a portion of his content access history for a set of content items Ring tones, Movie Clips, Wall Papers and Web Content as shown and categorized below:

Ring tones: 94
English: 54
   Jim Morrison and the Doors: 40
   Metallica: 10
   Britney Spears: 4
Spanish: 10
Hindi: 30

### Movie Clips: 152

English: 101
Hindi: 51

### Wall Papers: 578

English: 500
   Hollywood Actress: 490
      Sharon Stone: 400
      Julia Roberts: 90
      Hollywood Actors: 10
      Sean Connery: 2
      Arnold Schwarzenegger: 8
         Web sites: 21200
Ampelion sports web sites: 12579
   Football: 567
   Basketball: 2001
   Cricket: 10011
Ampelion news web sites: 1536
Ampelion health web site: 7085
   From the portion of the history database for a particular mobile user as indicated above, it can be understood that the mobile user prefers English language and his preference in music inclines towards “Jim Morrison and the Doors”, his preference in Hollywood actress inclines towards “Sharon Stone” and his preference for web sites inclines towards Ampelion sports web sites and particular about the sport “Cricket”. The numbers indicated across each content item in the above example represents the hit count for that particular class of content. It should be appreciated that the above example is merely an illustration and the content categories may be numerous and content access pattern may be represented in other appropriate forms in the iPCDS 300. The history database 318 will not have the actual mobile number of the mobile user to protect the privacy, but would have a unique mobile ID as designated by the mobile ID generator 306.

The system databases of the iPCDS 300 namely, operator database map 304, user opt-in-out database 308, the rules database 314, preference database 316, the history database 318, the recommendation database 410 (see FIG. 4) may be are automatically updated based on the mobile users' interaction with the iPCDS 300 and various elements of this sub-system. The system databases of the iPCDS 300 may use any native language, database management protocols, and nomenclature of the database and may be any commercially available databases like Microsoft SQL, Oracle database like Oracle 10g etc.

Processor architecture 320 may be implemented or realized with a general purpose processor, an application specific integrated circuit, discrete hardware components, or any combination thereof, designed to perform the functions described herein. A processor may also be implemented as a combination of computing devices, e.g., a combination of microprocessors, central processing units (CPUs), a plurality of microprocessors, configuration of microprocessors in single core or multi-core architectures, or any other such configuration. The processor architecture 320 can communicate with the various components and functional elements of iPCDS 300 and carry out processing tasks and techniques described herein.

Memory 322 may be implemented or realized with RAM/ROM memory, flash memory, EPROM/EEPROM memory, cache memory, hard disk, a removable disk, a CD-ROM, or any other form of storage medium and perform storage functions. In this regard, memory 336 can be coupled to any component of the iPCDS 300 such that any component can read information from, and write information to the memory 322. Memory 322 includes sufficient data storage capacity to support the operation of the iPCDS 300 described herein.

Operating system (OS) 328 is associated with computing platform as required by the iPCDS 300. The operating system 324 may be any suitable operating system such as Unix OS, Microsoft Windows Server OS, Linux on Advanced Telecom Computing Architecture (AdvancedTCA), Montavista Carrier Grade Linux Edition (CGE), Sun Microsystems Solaris OS or the like.

The protocols engine 326 is associated with computing platform as required by the iPCDS 300. The protocols engine 326 may include any protocol stacks for network access, signaling protocols, telecommunication protocols, data communication protocols and/or other transport protocols required by the iPCDS 300 to interface, communicate and/or transfer data over the mobile operator network infrastructure 104 (see FIG. 1) and/or interface, communicate, transfer data from/to the content database architecture 108 (see FIG. 1) including, but not limited to GSM/GPRS/3G/CDMA/WCDMA protocol stacks, SMSC/MMSC interfacing protocol stacks, Internet protocol stacks like TCP/IP, UDP, RTCP, SNMP and application level protocols like SMS application protocols etc. The protocols engine 326 architecture may also include middleware and application protocols like JBOSS Enterprise Middleware suite, Common Object Request Broker Architecture (CORBA), JAVA middleware suites (like J2EE) etc.

The functionality of processor architecture 320, memory 322, operating system 324, protocols engine 326, communication element 328, interconnect architecture 338 and the manner in which it governs the architectural, functional and operational aspects of the iPCDS 300 are known to those skilled in the art and will not be described herein.

The Communication element 328 generally refers to features and components, including hardware, drivers, software etc., that enable the iPCDS 300 to communicate with mobile operator network infrastructure 104 (see FIG. 1), other network components and devices like load balancers, firewalls, SMS application servers, content database servers using receive element RX 340 and transmit element TX 342 using standard communication protocols and/or utilizing the protocols engine 326 of the iPCDS 300.

The user interface 330 refers to any graphical, textual, auditory, command line interface provided to the administrator/user of the iPCDS 300 to control the operation and functionality of the iPCDS 300. It also refers to any graphical, textual, auditory, command line information the iPCDS 300 presents to the administrator/user. For example, using the user interface 330, the administrator 334 may query the iPCDS 300 to generate a recommendation mobile users group for a targeted personal content delivery or advertising campaign in the age group of 30-40 years who would be potential buyers for a premium apparel brand like “Armani”.

The intelligent recommendation engine 332 contains software, processing logic and/or algorithms and techniques used by the iPCDS 300 for making intelligent personalized recommendations content delivery or advertising to the mobile users accessing content hosted by the content service provider using the iPCDS 300. The intelligent recommendation engine 332 uses the profiling engine 402 (see FIG. 4) and the prediction engine 406 (see FIG. 4) functions to produce recommendations, based upon standard rules and/or mobile user's preferences, and/or access history and/or interactions with the sub-systems of iPCDS 300. The recommendation may be directly delivered to the mobile user when the mobile user is accessing content hosted by the content service provider using the iPCDS 300 and/or may be delivered at an appropriate time as desired by the mobile user and/or as identified by the iPCDS 300. The intelligent recommendation engine 332 may be designated to process data as predefined by the administrator or may provide an interface by which the administrator using the user interface 330 of the iPCDS 300, may query the system to generate a recommendation for a particular class of content delivery or a specific advertising campaign to a group of mobile users.

The accounting engine 334 generates log files containing Transaction Details for specific transactions made by the mobile user while accessing certain content which need to be billed to the end mobile user. The accounting engine 334 may also incorporate logic to check the balance of the pre-paid mobile subscriber accessing the content through the iPCDS 300. Such billing events are submitted to the mobile operator billing system 236 (see FIG. 2) through the communication link 280 (see FIG. 2). The manner in which communication channel is established and maintained over physical link 280 may be governed by one or more applicable communication protocols and/or one or more applicable network protocols. The creation of transaction details and submission of the transaction details to the billing system would be evident to those skilled in the art and hence not described herein.

The content database interface 336 may represent hardware, software, and/or processing logic that enables iPCDS 300 to communicate with content databases and/or content hosted on content servers like Tandberg Content servers, and Apple Quicktime servers etc., using the native language, database management protocols, and nomenclature of the database. For example, content database interface 336 is suitably configured to create a database query for a content requested by the mobile user using the iPCDS 300, when the mobile user is downloading a ring tone and deliver the ring tone requested by the mobile user in a format that is suitable for transmission by the iPCDS 300. Moreover, content database interface 302 obtains the requested content (or a portion thereof) from the content database and/or content server, so that the iPCDS 300 can process the requested data in an appropriate manner.

FIG. 4 is a schematic representation of the intelligent recommendation engine 400 in accordance to some example embodiment. Intelligent recommendation engine 400 is suitable to be used in iPCDS 300 (see FIG. 3). The intelligent recommendation engine 400 generally includes a profiling engine 402, a profiled database 404, prediction engine 406, a recommendation delivery engine 408, recommendation database 410, database interface 412 and an interconnect architecture 414.

The profiling engine 402 has two internal engines, the user profiler engine and the content profiler engine. The user profiler engine acts upon the information in the system databases of iPCDS 300 (see FIG. 3), namely the rules database 314 (see FIG. 3), the preference database 316 (see FIG. 3) and the history database 318 (see FIG. 3) and uses the user-content transaction cache 312 (see FIG. 3) and profiles the mobile users based on implicit and explicit relationship among the mobile users and the content elements and would build a profiled database 404. The content profiler engine categorizes and catalogues content supported by the iPCDS 106 (see FIG. 1) and may utilize the rules database 314 (see FIG. 3) for clustering and pattern matching to suggest the appropriate right content to a specific mobile user or to a group of mobile users.

The profiled database 404 has two internal databases, the user profiled database and the content profiled database. The profiled database may contain information of the user and/or content in any relational form or any other data formats (like flat files, linked lists etc). The profiled database 404 (both user profiled database and content profiled database) is updated by the profiling engine 402.

The prediction engine 406 performs information filtering and may utilize one or more combination of algorithms like, and not limited to, content based algorithms, collaborative filtering algorithms, a combination of hybrid algorithms and artificial intelligence techniques. Content based algorithms may use content-to-content matching and/or comparison to generate recommendations. The algorithms used for this purpose may include one or more combination of Bayesian techniques, decision trees, association rules and the like. Collaborative filtering algorithms may use user profile matching. The recommendations to the mobile users are based on comparison of similar content pertinent to the user and predicting new content items to the user or a group of users. The algorithms used herein may include one or more combination of nearest neighbor, cosine clustering, classifier matrix types and the like. Hybrid algorithms use a combination of user files and item matching techniques. Recommendations are based on pertinent user's interests and the category of content liked by the user and/or related advertisements related to the category of the content liked by the mobile user. The result of the prediction engine 406 is updated to the recommendation database. Also the results of the prediction engine 406 may be used internally by the iPCDS 106 (see FIG. 1) to update the various sub-systems of iPCDS 300 (see FIG. 3) as required like the rules database, preference database etc. The prediction engine 406 may enforce user privacy policy and/or digital rights for content items as required. The predictive engine 406 uses advanced statistical and artificial intelligence techniques to increase the accuracy of personalized recommendations by the iPCDS 300 (see FIG. 3) when the number of mobile users in the system is large and when the complexity of the system increases making the system non-linear. The prediction engine 406 may use algorithms to handle the system non-linearity by using a combination of clustering with correlation techniques, combination of dimensionality reduction and similarity techniques and the like.

The recommendation delivery engine 408 transfers the recommendations in the recommendation database 410 to the internal database of the operator database map 304 (see FIG. 3) through the interconnect architecture 338. The internal database of the operator database map 304 contains intelligent personalized content recommendations for mobile users to be used by the mobile operator and/or the content service provider using the iPCDS 106 (see FIG. 1) with a Service Level Agreement (SLA) with the mobile operator (like Cingular in the USA or Airtel in India), to deliver content and/or advertisements to mobile user 102 (see FIG. 1). Also when a administrator using the iPCDS 300 queries the system using the user interface 330 to generate a recommendation for a particular class of content delivery or a specific advertising campaign to a group of mobile users, the personalized recommendations generated by the intelligent recommendation engine 400, is transferred from the recommendation database 410 to the operator database map 304 (see FIG. 3) by the recommendation delivery engine 408.

The recommendation database 410 contains the intelligent personalized recommendations for the mobile users generated by prediction engine 406 (see FIG. 4) of the iPCDS 300 (see FIG. 3). The recommendation database 410 may be organized as a single large database or may be organized as several group databases. The recommendations for mobile users may be in the single large database and/or group databases and/or may be organized as data clusters. The databases may be generated automatically as pre-defined by the administrator/user of the iPCDS 300 or may be generated when the iPCDS 300 is queried by the administrator. The recommendation database 410 will not have the actual mobile number of the mobile user to protect the privacy, but would have a unique mobile ID as designated by the mobile ID generator 306. A portion of the recommendation database 410 may be as shown below:

Operator: Cingular (USA)

| | Preferences | | | | |
|---|---|---|---|---|---|
| Mobile ID | Ring Tones | Movie Clips | Web Sites | . . . | Wall Papers |
| 0x0001 | English | Comedy | Sports - | . . . | Sharon Stone |
| | | | Basketball | | |
| . | . | . | . | . | . |
| . | . | . | . | . | . |
| . | . | . | . | . | . |
| 0x300F | Spanish | Action | Sports - | . . . | Arnold |
| | | | Football | | |

### The above database table is merely for illustration only and hence, by no way, limits the format and/or presentation in the database.

FIG. 5 is a schematic representation of the profiling engine 500 in accordance to some example embodiment. Profiling engine 500 is suitable to be used in intelligent recommendation engine 400 (see FIG. 4). The profiling engine 500 generally includes a database interface 502, a feedback engine 504, profile adaptation engine 506, user-profile database 508, user profile learning engine 510, user history processing engine 512, user clustering engine 514, and content clustering engine 516. Interconnect architecture 518 allows the various elements of the profiling engine 500 to communicate with each other and transfer data as needed.

The database interface 502 may represent hardware, software, and/or processing logic that enables the profiling engine 500 to communicate with system databases like rules database 314, preference database 316, history database 318, and profiled database 404 (see FIG. 4) and user-content transaction cache using the native language, database management protocols, and nomenclature of the database.

The feedback engine 504 provides feedback about the user-content relationship as identified by the iPCDS 106 (see FIG. 1). The feedback engine 504 analyzes results generated by various sub-systems of the profiling engine 500 like the user profile learning engine 510, user history processing engine 512 and others, for extracting latest user-content implicit and/or explicit relationship and input this data to the profile adaptation engine 506.

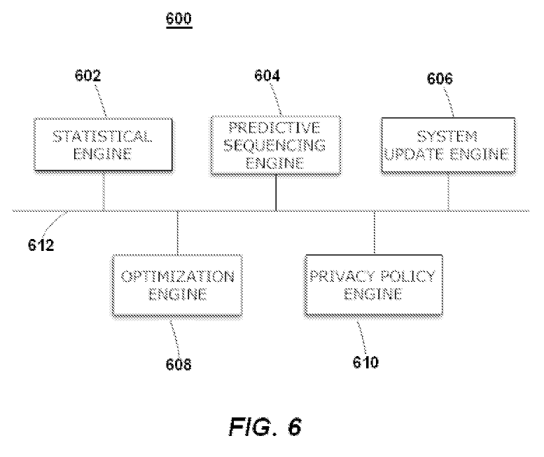

The profile adaptation engine 506 may process feedback information from the feedback engine 504 and/or process information from the system update engine 606 (see FIG. 6) of the prediction engine 600. The profile adaptation engine 506 adapts the internal feedback from the feedback engine 506 and the intelligent recommendations from the prediction engine 600 and builds the user-profile database 508.

The user-profile database 508 is generated by the profile adaptation engine 506. This database contains user-profiles and association of the user to various categories of content. The user-profile database 508 is transferred to the profiled database 404 (see FIG. 4) of the intelligent recommendation engine for further processing by the intelligent recommendation engine 400.

The user profile learning engine 510 interacts with the user-content transaction cache 312 (see FIG. 3) and contains various functions and algorithms that analyze the user-content transactions and/or user-content access patterns to generate the history database 318. The user profile learning engine 510 acts upon the information in the user-content transaction cache 312 and profiles the mobile users based on standard rules defined in the rules database 314, preferences of the mobile user if available in the preference database 316 and would build a history of the mobile users in the history database 318.

The user history processing engine 512 acts upon the information in the history database 318 (see FIG. 3) and contains various functions and algorithms to extract various appropriate characteristics of the mobile user-content relationship including, but not limited to, content access patterns, duration of access, temporal patterns etc.

The user clustering engine 514 includes techniques and algorithms to deal with large number of mobile users and optimally clusters users to decrease complexity in the iPCDS 300 due to huge number of users and introduces non-linearity to the system. The clustering techniques may include standard fuzzy clustering techniques and the like. The feedback engine 540 utilizes the processed data of the user clustering engine as required.

The content clustering engine 516 includes techniques and algorithms to optimally cluster content items used by the iPCDS 300 (see FIG. 3) for association with mobile users. The content clustering techniques may include standard clustering techniques like similarity and pattern matching etc. The processed data of the content clustering engine 516 may be utilized to update the rules database 314 (see FIG. 3).

FIG. 6 is a schematic representation of the prediction engine 600 in accordance to some example embodiment. Prediction engine 600 is suitable to be used in intelligent recommendation engine 400 (see FIG. 4). The prediction engine 600 generally includes a statistical engine 602, a predictive sequencing engine 604, a system update engine 606, an optimization engine 608 and a privacy policy engine 610.

The statistical engine 602 contains software, processing logic and/or algorithms and techniques used by the predictive engine 600 of the intelligent recommendation engine 400 for mathematical and/or statistical analysis of mobile users and their association to content items. In practical embodiments the statistical engine 602 may be incorporated as part of the intelligent recommendation engine 400 or may be an independent element as shown in the sample embodiment of prediction engine 600. The statistical engine may incorporate statistical techniques including, but not limited to, stochastic processes, heuristic approximations, collaborative filtering techniques, probabilistic clustering, Bayesian analytical techniques, k-nearest neighbor techniques, Pearson correlation co-efficient techniques, co-sine measures, vector machine-based techniques, or any other statistical analytical techniques. The statistical engine 602 may also include any newly derived statistical techniques and enhanced statistical algorithms. The statistical engine 602 works on the profiled database 404 (see FIG. 4) and generates recommendations for mobile users of the iPCDS 106 (see FIG. 1).

The predictive sequencing engine 604 schedules and prioritizes various activities to be taken by the prediction engine 600. Based on the configuration of the iPCDS 106 (see FIG. 1) by the administrator, the prediction engine schedules the recommendations to be generated and/or directs updates to the sub-systems of the iPCDS 300 (see FIG. 3).

The system update engine 606 uses the intelligent recommendation for mobile users generated by the statistical engine 602 and/or optimization engine 608 and builds the recommendation database 410 (see FIG. 4). The system update engine 606 also inputs intelligent recommendations back to the profile adaptation engine 506 (see FIG. 5) for future iterations by the iPCDS 300 (see FIG. 3).

The optimization engine 608 contains software, processing logic and/or algorithms and techniques used by the prediction engine 600 of the intelligent recommendation engine 400 for making intelligent analysis and optimal association of mobile users to content items. In practical embodiments the optimization engine includes statistical and/or artificial intelligence techniques. It may be incorporated as part of the intelligent recommendation engine 400 or may be an independent element as shown in the sample embodiment of prediction engine 600. The optimization engine may incorporate artificial intelligence techniques including, but not limited to, Case Based Reasoning (CBRs), techniques introducing drift parameters (forgetting factors) to CBRs and the like.

The privacy policy engine 610 governs the privacy policy for the mobile users of the iPCDS 106 (see FIG. 1). The privacy policy may be associated with each mobile user or a group of mobile users based on the feedback from the mobile users. The privacy policy may enforce the level of tracking for mobile users content access patterns and/or impact the mobile user's opt-in or opt-out behavior. The user may opt-in for a set of services offered by the content service provider using the iPCDS 106 (see FIG. 1) and the user may opt-out for certain services imposing certain privacy guidelines. The privacy policy engine 610 may also manage the digital rights for various content categories. For example the privacy policy engine may interface with Digital Rights Management (DRM) software from other vendors and content providers to enforce and protect content privacy and enforce DRM policies.

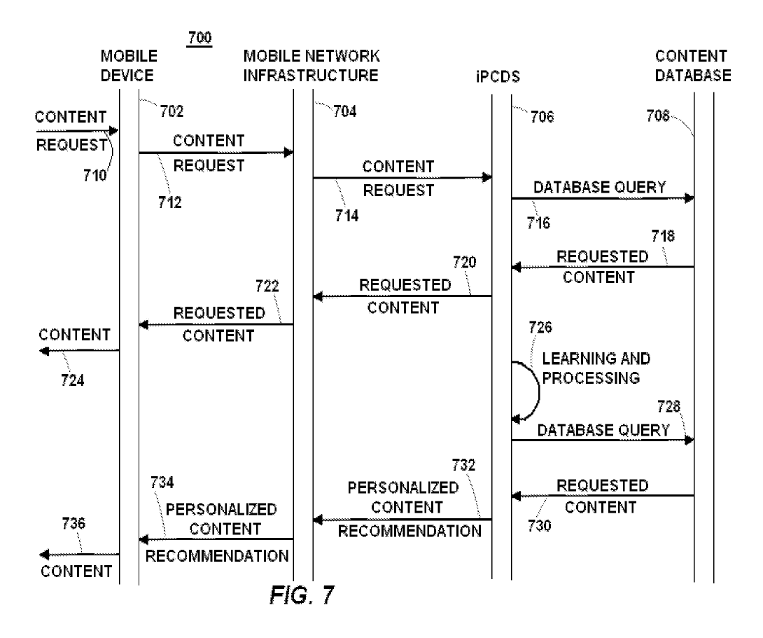

A typical intelligent personalized content (recommended content and/or advertising content) delivery operation for a mobile device will now be described with reference to FIG. 7. FIG. 7 is a timing diagram 700 that representing the usage aspect wherein the content is requested by the mobile user using the mobile device over the mobile network infrastructure and the iPCDS delivering the desired content to the mobile user and also delivering personalized content recommendations and/or advertisements after learning and intelligent processing. The vertical bars in FIG. 7 represent the components of iPCDS according to some embodiment: a wireless mobile device 702; mobile network infrastructure 704; iPCDS 706; and content database 708. In FIG. 7, events occur in time from the top of timing diagram 700 to the bottom of timing diagram 700. In practical embodiments, it should also be appreciated that these events may include any number of additional or alternative tasks, and also the tasks shown in the FIG. 7 need not be performed in the illustrated order, and the tasks may be incorporated into more comprehensive procedures and/or processes having additional functionality not described in detail herein.

The mobile user uses the mobile device to access content. For example, the mobile user may send a SMS to the SMS short code as predefined by the content service provider to download a ring tone or may access the web page of the content service provider to access his interested sports content using HTTP. The process begins with mobile device 702 sending a content request. The timing diagram 700 identifies the content request with an arrow 710. Wireless mobile device 702 sends the content request to the mobile network infrastructure 704 in accordance to the wireless communication protocols utilized by the mobile communication infrastructure 704. The content request may be realized as one or more data packets, for accessing desired content from the content service provider.

The wireless mobile device 702 transmits the content request via a wireless link. The timing diagram 700 depicts the wireless transmission of the content request with an arrow 712. Thereafter, the content request is handled by the mobile network infrastructure suitably and transmits the content request to the network domain of the content service provider hosting the iPCDS 706 and the required content databases 708. Timing diagram 700 depicts this transmission of the content request to iPCDS with an arrow 714. The operation of mobile network infrastructure is not described herein as it is know to those skilled in the art.

The iPCDS 706 may simply forward the content request to content database 708 as a suitably formatted database query denoted by the arrow 716 in the timing diagram. The Content database 708 suitably responds with the requested content shown by the arrow 718 in the timing diagram 700. The requested content is sent to the mobile network infrastructure 704 in a suitable format as needed and this is depicted with an arrow 720 in the timing diagram 700. The mobile network infrastructure 704 then sends the requested content over the wireless link to the mobile device 702 of the user as depicted by the arrow 722 in the timing diagram 700. The requested content represented by the arrow 722 is suitably processed by the mobile device 702 to render the content as depicted by the arrow 724 to the mobile user.

The iPCDS may also duplicate the content request 714 received from the mobile user as required for learning and further processing and for delivering intelligent personalized content recommendations as per mobile users preferences and/or for providing relevant targeted advertisements. The learning and processing of the content request is represented in the timing diagram by the semi-curved arrow 726.

The iPCDS 706 has various elements as described earlier with an example embodiment of the iPCDS (see FIG. 3-6). The iPCDS 706 processes the received content request in a suitable manner to learn the preferences and processes the data to generate intelligent personalized recommendations which may be used later to deliver personalized content recommendations and/or targeted advertisements to the mobile users. The iPCDS 706 may fetch the suitable content for mobile users from the content database 708 by querying the database. In the timing diagram 700 this is depicted by the arrow 728. The content database 708 responds appropriately with the content as queried by the iPCDS 706 as denoted by the arrow 730. The iPCDS then transmits the personalized content recommendation and/or targeted advertisements to the mobile user using the mobile network infrastructure 704. This is denoted by the arrows 732 and 734. The personalized content is now delivered to the user through the mobile device 702 after suitable processing at the mobile device as denoted by the arrow 736 in the timing diagram 700.

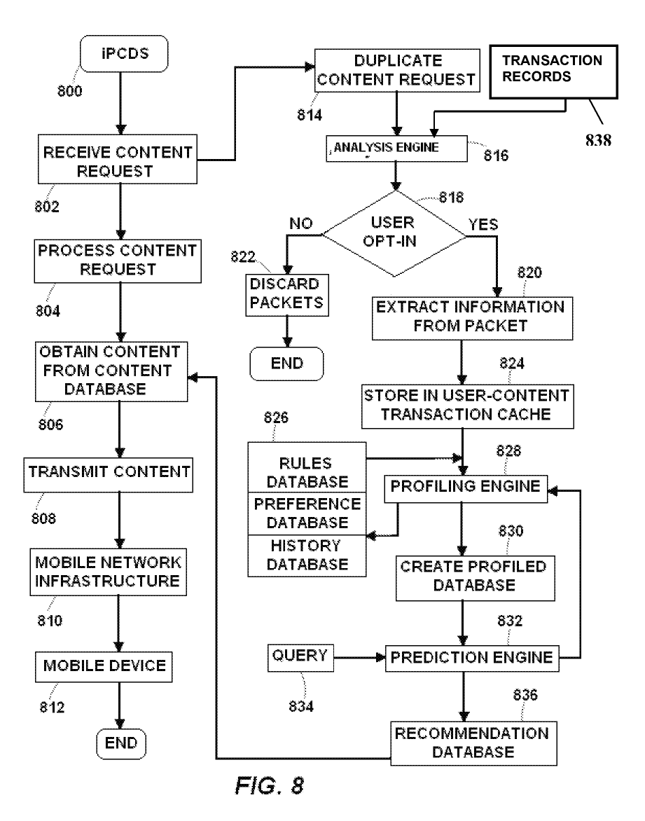

FIG. 8 is a flow chart of a portion of a recommendation generation process and content delivery to a mobile device, as performed by the intelligent personalized content delivery server system (iPCDS). The tasks depicted in FIG. 8 are identified as iPCDS process 800 also including the associated content delivery process. For illustrative purposes, the following description of server process 800 may refer to elements mentioned above in connection with FIGS. 1-6. In practical embodiments, portions of these processes may be performed by different elements of the described system, e.g., the wireless mobile device, the mobile network infrastructure or the iPCDS. It should be appreciated that these processes may include any number of additional or alternative tasks, and the processes shown in the figure need not be performed in the illustrated order, and the processes may be incorporated into a more comprehensive procedure or process having additional functionality not described in detail herein.

The intelligent personalized content delivery system process begins with a wireless mobile device 702 (see FIG. 7) acquiring a content request input from the mobile user. The wireless mobile device 702 transmits the content request via a wireless link to the mobile network infrastructure 704 (see FIG. 7). Thereafter, the content request is handled by the mobile network infrastructure suitably and transmits the content request to the network domain of the content service provider hosting the iPCDS 706 (see FIG. 7). This initiates the iPCDS process 800 (see FIG. 8). The iPCDS receives the content request (task 802) and suitably processes the content request. This is depicted by the task 804 in FIG. 8. The iPCDS may format a suitable database query for compliance with the content database 708 (see FIG. 7) and query the content database for the required content. The content database suitably responds with the requested content as part of the task 806. The content is sent to the mobile network infrastructure 704 (see FIG. 7) in a suitable format and this is depicted by the task 808. The mobile network infrastructure 704 then sends the content over the wireless link to the mobile device 702 of the user depicted by the task 810. The content is suitably processed (task 812) by the mobile device 702 (see FIG. 7) to render the content to the mobile user.

The iPCDS process/task 800 may also duplicate the content request and store it for further processing by the system depicted by the task 814. The analysis engine process 816 examines and extracts relevant information (task 820) from the content request packets. The analysis engine process 816 may also examine and extract relevant information from other sources like the transaction records including but not limited to transaction detail records, transaction logs, transaction server logs, electronic-commerce and mobile-commerce payment gateways transaction logs. The input of the transaction records is depicted by the task 834. Alternatively the analysis engine process may also verify the preference of the mobile user and may discard the packets without processing for mobile users who have not opted-in for personal recommendations as depicted by task 822. The user-content relationship generated is transmitted and stored in the user-content transaction cache as depicted in task 824. The profiling engine process 828 may interact with rules database, preference database, and history database and create the profiled database. These are performed as part of tasks associated with multiple sub-systems and tasks of the iPCDS described herein (see FIG. 3-6). The interaction of profiling engine with the databases is depicted by the task 826. The profiling engine (see FIG. 5) creates the profiled database using the information in the user-content transaction cache and the other databases identified by task 830. The prediction engine (see FIG. 6) process 832 builds the intelligent recommendation database which contains the user-content preference relationship. This process 832 may also update the profiling engine elements. The profiling engine process 828 may also update the system databases like the rules database, preference database and history database (task 828). Alternatively, the administrator/user of the iPCDS may issue queries to generate certain personalized recommendations and this is handled by the task 834. The prediction engine process 832 may suitably generate the personalized recommendations and store them in the recommendation database (task 836). The iPCDS may utilize the user-content relationship in the recommendation database to fetch relevant content for the mobile users or a group of mobile users (task 806). The personalized content and/or targeted advertisement or a recommendation URL is sent to the mobile network infrastructure 704 (see FIG. 7) in a suitable format and this is depicted by the task 808. The mobile network infrastructure 704 then sends the content over the wireless link to the mobile device 702 of the user depicted by the task 810. The content is suitably processed (task 812) by the mobile device 702 (see FIG. 7) to render the content to the mobile user.

What is claimed is:

1. A method for personalized content delivery for wireless devices, said method comprising;
acquiring a content request input from a user;
transmitting the content request wirelessly;
processing of transmitted content request by intelligent personalized content delivery server (iPCDS) to learn user preferences and to initiate intelligent personalized recommendations and to format a suitable database query;
obtaining requested content from a content database to said query; and
transmitting obtained content to device for suitable processing to render the content to the user.

2. A method of processing content request of wireless device user by intelligent personalized content delivery server (iPCDS) comprises;
acquiring mobile user preference through predefined registration of user preference and/or automatically learning the user preference on the fly while user access the content;
decoding the content accessed by the user and/or analyzing the user transaction details records/transaction logs/transaction server logs and caching the user content data for building a history database for every user based on predefined standard rule, building preference database and the mobile user content access patterns, building recommendation database periodically as predefined by content delivery system.

3. The method as claimed in claim 2, wherein the method transmits the relevant personalized content to the user based on the recommendation database in accordance with a mobile wireless communication protocol.

4. The method as claimed in claim 1, wherein the content is selected from a group consisting of ring tones, MMS clips, SMS, text, HTTP content, web pages, games, advertisements and advertising content, graphics, audio, video, interactive forms of content, advertisements in URLs, content recommendation URLs, e-commerce or nm-commerce advertisements in URLs, applets, streaming audio, streaming video, demonstrations, software applications, executable code, and computer programs.

5. The method as claimed in claim 1, wherein the personalized recommendation for content delivery uses mathematical and/or statistical techniques and/or artificial intelligence techniques to recommend content items to mobile users, wherein techniques comprises:
Automatically learning mobile user preferences on the fly with out intervention from the user; and
providing users with no options to rate content items or content categories and preference items and generate recommendations without user ratings.

6. The method as claimed in claim 1, wherein the content database is suitably configured to handle all types of contents selected from a group consisting of Hyper Text Transfer Protocol (HTTP) Web pages, XML pages, RSS feed formats, WAP pages, Binary Runtime Environment for Wireless (BREW) formats, games, graphics, mobile Ring Tones and MMS files, MPEG files, MP3 files, MOV files, JPEG files, GIF files, streaming video files, video files, Real Networks RealAudio and RealVideo, Windows media formats, 3GPP file formats, Apple QuickTime formats and combination thereof.

7. A system for personalized content delivery for wireless devices, said system comprises;
a mobile device to acquire content request from a user;
a mobile access network infrastructure to transmit data;
an intelligent personalized content delivery server system (iPCDS) deployed within the mobile operator network and/or remotely deployed network to process content request; and
a content database.

8. The system as claimed in claim 7, wherein the mobile device preferably wireless mobile device is configured to support wireless GSM/GPRS/3G/CDMA/W-CDMA connectivity in compliance with established European Telecommunications Standards Institute (ETSI), International Telecommunication Union (ITU) standards and Third Generation Partnership Project (3GPP) standards and also supports alternate or additional wireless data communication protocols comprising future variations of 3G preferably 3.9G/4G, and other wireless communication standards preferably BlueTooth, WLANs (802.11a/b/g), WiMAX (802.16).

9. The system as claimed in claim 7, wherein the intelligent personalized content delivery server system is an intermediary between the mobile access network infrastructure and the content database.

10. The system as claimed in claim 7, wherein the iPCDS system communicates with the content database to retrieve content data as requested by the user, and/or transmit personalized content or advertising content based on intelligent recommendations built by the iPCDS in an appropriate format for presentation at the wireless mobile device.

11. The system as claimed in claim 7, wherein the iPCDS couples with mobile operator billing systems using communication link.

12. An intelligent personalized content delivery server (iPCDS) system for processing content request of wireless device user comprises a system database interface, operator database map, a mobile ID generator, a user opt-in-out database, an analysis engine, a user-content transaction cache, a rules database, a preference database, a history database, processor architecture, memory, an operating system, protocols engine, communication element with receive element RX and transmit element TX, an user interface, an intelligent recommendation engine, an accounting engine, and content database interface.

13. The system as claimed in claim 12, wherein the system database interface enables sub-systems of iPCDS to communicate with system database selected from a group consisting of operator database map, user opt-in-out database, rules database, preference database, history database, and recommendation database using the native language, database management protocols, and nomenclature of the database.

14. The system as claimed in claim 12, wherein the operator database map comprises two internal database, wherein one internal database contains mobile user data collected from the mobile operator and the other internal database contains intelligent personalized content recommendations for mobile users to be used by the mobile operator to deliver content including advertisements to his subscribed mobile users

15. The system as claimed in claim 12, wherein the analysis engine enables iPCDS to decode and analyze real time traffic passing through the iPCDS when content hosted on content database is being accessed by the user.

16. The system as claimed in claim 12, wherein the analysis engine enables iPCDS to analyze transaction details records/transaction logs/transaction server logs from mobile operators and internet service providers/mobile value added service providers/electronic-commerce and mobile-commerce service providers.

17. The system as claimed in claim 12, wherein the user-content transaction cache comprises list of mobile IDs and their content access patterns learnt on the fly using the analysis engine of the iPCDS.

18. The system as claimed in claim 12, wherein the rules database comprises two internal rule databases;
mobile user rule database comprises a set of standard and/or derived rules and logic to effectively associate a particular mobile user or a group of mobile users to a particular recommendation group in the recommendation database based on patterns as observed and/or identified; and
content item rule database comprises a set of standard and/or derived rules and logic to efficiently associate a particular content item or a group of content items to a particular class of content.

19. The system as claimed in claim 12, wherein the preference database comprises the preferences of the mobile users collected by the content provider of the iPCDS and also the preferences are collected through web registration on the content provider's web site and/or content service provider's web site or collected from the mobile network operator or collected through SMS key words or messages and/or other communication like web registration from the mobile device or from the mobile user indicating user's preferences for a particular service or multiple services along with other personal, demographic data and/or preferential information as requested by the content provider using the iPCDS.

20. The system claimed in claim 13, wherein the system databases are automatically updates based on the mobile users' interaction with the iPCDS and plurality of its sub-system.

21. The system as claimed in claim 12, wherein the processor architecture is realized with a general purpose processor, an application specific integrated circuit, discrete hardware components or any combination thereof.

22. The system as claimed in claim 12, wherein the intelligent recommendation engine uses the profiling engine and the prediction engine to produce recommendations, based upon standard rules and/or mobile user's preferences and/or access history and/or interactions with the sub-systems of iPCDS.

23. The system as claimed in claim 12, wherein the accounting engine generates log files containing transaction details for specific transactions made by the mobile user while accessing specific content which needs to be billed to the end mobile user and accordingly, the engine incorporate logic to check the balance of the pre-paid mobile subscriber accessing the content through the iPCDS.

24. The system as claimed in claim 12, wherein the intelligent recommendation engine comprises a profiling engine, a profiled database, prediction engine, a recommendation delivery engine, recommendation database, database interface and an interconnect architecture.

25. The system as claimed in claim 23, wherein the profiling engine comprises a database interface, a feedback engine, profile adaptation engine, user profile database, user profile learning engine, user history processing engine, user clustering engine and content clustering engine.

26. The system as claimed in claim 24, wherein the user profile learning engine interacts with the user-content transaction cache and analyzes the user-content transactions and/or user-content access patters to generate the history database.

27. The system as claimed in claim 23, wherein the prediction engine comprises a statistical engine, a predictive sequence engine, a system update engine, an optimization engine and privacy policy engine.
